(19) United States
(12) Patent Application Publication
(10) Pub. No.: US 2004/0012105 A1
(43) Pub. Date: Jan. 22, 2004

(54) Polystyrene microspheres and a method for their production

(76) Inventors: Holger Deppe, Frankfurt/Main (DE); Hanns Wurziger, Darmstadt (DE); Andreas Schober, Darmstadt (DE); Egbert Brandau, Alzenau (DE); Thorsten Brandau, Frankfurt/Main (DE); Esther Daldrop, Dietzenbach (DE)

Correspondence Address: MILLEN, WHITE, ZELANO & BRANIGAN, P.C., 2200 CLARENDON BLVD., SUITE 1400, ARLINGTON, VA, 22201, US

(21) Appl. No.: 10/381,136

(22) PCT Filed: Sep. 13, 2001
(86) PCT No.: PCT/EP01/10586

(30) Foreign Application Priority Data
Sep. 21, 2000 (DE) 100 46 755.5

(51) Int. Cl. B01J 13/02

(52) U.S. Cl. 264/4; 428/402.2; 428/402.24

(57) ABSTRACT

The invention relates to microspheres with a narrow distribution of particle size and a uniform spherical shape, consisting of a partially or completely cross-linked polymer material. The invention also relates to a method for producing said microspheres and to the use thereof.

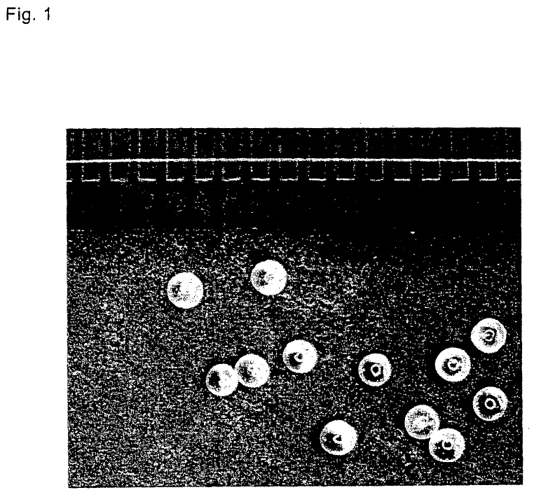

The present invention relates to microbeads having a narrow particle size distribution and a uniform bead shape, consisting of partially or fully crosslinked polymer material. The invention likewise relates to a process for the production of these microbeads and to their use.

To date, microbeads made from polymer materials, in particular from polystyrene, which are required for a very wide variety of industrial areas of application, are predominantly produced in emulsion polymerisation processes. In these, a mixture of styrene and crosslinking agent, for example divinylbenzene, is added to an aqueous solution comprising the polymerisation catalyst in a stirred reactor. This mixture is stirred at a defined speed, with formation of an emulsion (o/w) consisting of organic styrene/divinylbenzene beads in the aqueous solution. The polymerisation catalyst initially introduced in the aqueous solution is often potassium peroxodisulfate. In a variation of the process, the polymerisation catalyst may also already have been added to the styrene/divinylbenzene mixture. In this case, dibenzoyl peroxide is very often used as free-radical former.

The polystyrene microbeads produced by the processes known hitherto have a very broad particle size distribution and a frequently quite non-uniform shape. The formation of a uniform and narrow particle size distribution in the stirred emulsion is prevented by the constant formation and reformation of the beads. A variation of the composition and pre-polymerisation in order to achieve modified properties which are more suitable for a desired industrial application are only possible with difficulty in the emulsion polymerisation process. The formation of an outer protective colloid or a protective sheath during the polymerisation is likewise only possible in the form that inorganic compounds, such as magnesium chloride, phosphates, bentonites or the like, are added to the aqueous solution. Although this limits agglomeration, optical-monitoring and control of bead formation and the polymerisation is, however, no longer possible.

The object of the present invention is therefore to provide a process by means of which polymer microbeads can be produced in monodisperse form with varying crosslinking agent additions, catalysts and additives. The object of the present invention is also to provide a process for the production of microbeads of this type which can be carried out without agglomeration during the polymerisation and which enables controlled polymerisation. It should furthermore make it possible to design the polymerisation of the monomers so that it can be controlled and monitored through physical and/or chemical influences, so that polymerised polymer microbeads which have variable chemical and physical properties and which are matched to the target application can be produced.

A further object of the invention is to provide polymer microbeads having a very narrow particle size distribution which do not change during the polymerisation reactions, which also take place and are continued or only commence after formation of the bead shape.

The object is achieved by microbeads having an inner spherical core which comprises one or more monomer(s), crosslinking agents, additives and peroxide, and an outer bead shell which consists of a chemically cured protective colloid, and by a process for the production of microbeads from polymer materials having a narrow particle size distribution in the range from 50 to 2000 μm and a uniform bead shape, in which

a) droplets of a reactive mixture which comprises one or more polymerisable monomer(s) and has a liquid to viscous flowable consistency emerging from an inner nozzle

b) are surrounded with a separation and protective liquid emerging from a coaxially arranged outer nozzle and

c) are introduced dropwise into a curing solution under suitable conditions under which the bead shape formed during the falling is retained,

d) the outer protective sheath is cured under the influence of the curing agent solution,

e) the mixture comprising one or more monomer(s) is polymerised and cured in spherical shape after the temperature has been increased without the beads formed agglomerating or sticking together, and

f) the outer protective sheath is removed by a chemical reaction or by washing after the polymerisation and curing, and

g) the microbeads formed are separated off.

The present invention is also achieved by particular embodiments of the process according to the invention which are the subject-matter of claims 4 to 16. The invention furthermore also relates to the use of the resultant microbeads according to claims 17 to 20, such as, for example, as support materials for ion exchangers or for reactive moieties or in combinatorial synthesis.

The production of the microbeads according to the invention from partially or fully crosslinked polymer material in the particle size range between 50 μm and 2000 μm is carried out by formation of droplets of reaction liquid mixture dispensed by at least one nozzle. The nozzle dispensing the reaction liquid is surrounded by a coaxially arranged outer nozzle, a so-called ring gap nozzle, through which a separation and protective liquid is passed. This liquid surrounds the resultant droplets of the reaction liquid comprising one or more polymerisable monomer(s) during dropwise addition into a curing solution. The curing solution effects curing of the outer protective sheath and prevents agglomeration of the resultant droplets of monomer-containing reaction liquid. The monomer/crosslinking agent/catalyst mixture in spherical shape, surrounded by a protective sheath, then cures completely without the microbeads formed being able to stick together or agglomerate with the adjacent beads during complete curing.

Corresponding partially crosslinked microbeads are used for a variety of purposes, for example as support materials for ion exchangers or for combinatorial synthesis, in which the polymer material is modified by chemical derivatisation in such a way that reactive moieties are obtained for further chemical reactions.

The problem is solved in accordance with the invention in that the starting solution of the monomer(s) is mixed with a suitable crosslinking molecule, a catalyst for the polymerisation, which provides the radicals needed for the polymerisation at slightly or greatly elevated temperature, and additives which produce the requisite chemical properties of the polymerised and crosslinked polymer for use in combinatorial synthesis.

Polymerisable monomers which can be employed are styrene, styrene derivatives, unsaturated olefins, such as butadiene, pentadiene, vinyl and (meth)acrylic compounds, cyclic ethers, cyclic esters, cyclic amides, such as oxiranes, lactones or lactams, unsaturated cyclic hydrocarbons, cyclic isocyanates, cyclic H-acidic amino compounds, cyclic hydroxyl or carboxyl compounds, in the presence of suitable additives and catalysts. These monomers can be employed in the process according to the invention individually or in the form of a mixture. The more detailed form of the invention is described below with reference to the example of styrene, it being readily possible for the person skilled in the art to modify and adapt this process to the use of other suitable monomers.

A starting solution consisting of a polymerisable mixture, such as, for example, styrene, styrene derivatives, such as 4-bromostyrene, or suitable acrylic acid derivatives, a crosslinking agent compound (for example divinylbenzene, diethylene glycol bis(allyl carbonate), diallyl phthalate, methylstyrene, methyl acrylate, methyl methacrylate, hydroxyethyl methacrylate, 1,4-butanediol dimethacrylate, trimethylolpropane trimethacrylate and other di- and trivinyl compounds, and di-, tri- and tetraacrylates or -methacrylates), a free-radical former, generally an organic peroxide compound (for example dibenzoyl peroxide, dilauroyl peroxide, tert-butyl peroctanoate, tert-butyl perbenzoate, dicumyl peroxide, di-tert-butyl peroxide, cumene hydroperoxide, tert-butyl hydroperoxide, tert-butyl peroxyneodecanoate, other peroxyesters and mixtures of organic peroxides), is forced through an inner nozzle at low pressure, forming a laminar stream, which is split into individual droplets by the applied vibration at the nozzle or the vibration into the solution by means of a flexible element. These droplets form uniform beads owing to their surface tension. An outer nozzle, in the form of a ring gap nozzle, through which a protective colloid solution is forced, is arranged around the inner nozzle. Due to the vibration with a frequency of from 20 Hz to 10,000 Hz, microbeads are formed which comprise spherical cores comprising styrene, crosslinking agent and peroxide in-the interior, and outer bead shells consisting of the protective colloid solution.

After a short fall, these microbeads consisting of core and shell are transferred into a reaction solution, in which the outer shell is chemically cured. These capsules containing styrene, crosslinking agent and peroxide which then formed are subjected to a temperature increase in order to initiate or accelerate the polymerisation reaction of the styrene and the crosslinking.

After complete polymerisation of the inner beads, the protective layer is removed by chemical reaction or by washing with gentle stirring.

The polymerisation time can be shortened or moved to lower temperatures by means of suitable accelerators (for example N,N-dimethylaniline, N,N-dimethyl-o-toluidine, N,N-diethylaniline, Co octanoate, Cu octanoate or other accelerator compounds).

Further control of the polymerisation consists in adding suitable inhibitors (for example hydroquinone, p-benzoquinone, pyrocatechol, tert-butylhydroquinone, 4-tert-butylpyrocatechol, 3,5-di-tert-butylpyrocatechol, 2,5-di-tert-butylhydroquinone, hydroquinone monomethyl ether or other free-radical scavengers) to the starting solution in order to vary the gelling time, i.e. the time before polymerisation commences, and to be able to adjust it in a suitable manner for the procedure of shaping to give microbeads.

A refinement of the invention consists in partially pre-polymerising the freshly prepared mixture of styrene, crosslinking agent and catalyst until a droplet-forming viscosity is still not exceeded. This can be carried out in a water bath or fan-assisted oven at temperatures of 30-60° C. over a period of 1-24 hours.

The pre-polymerisation, like the further full polymerisation, is dependent on the composition of the starting mixture and the type of crosslinking agent substances, the polymerisation catalysts, the inhibitors and the other additives.

The microbeads according to the invention can be produced by processes which correspond to the process described in detail in the patent specifications DE 41 25 133 C2 and EP 0 735 940 B1. This is a vibration droplet-formation process, in which a styrene-containing liquid mixture or a flowable viscous mixture which has already been partially pre-polymerised is formed into droplets by vibration excitation of the nozzle device. This droplet formation process has the advantage that a monodisperse distribution of the resultant spherical particles is obtained. Through the use of a coaxial double nozzle, i.e. an inner nozzle with a surrounding outer ring gap nozzle, the inner polystyrene beads and the outer protective colloid bead shell automatically form in a spherical shape. As has already been shown in the above specifications, the desired bead shape of the droplets forms during the falling and is retained during curing of the protective sheath in the curing agent liquid and the subsequent polymerisation. In order as far as possible to avoid modifying the bead shape when it hits the curing agent liquid, the fall path of the droplets is arranged in such a way that the droplets enter the curing agent liquid tangentially or approximately tangentially or at least at an acute angle to the liquid surface. The fall path here is variable and is set in such a way that the droplets are able to form a spherical geometry in the free-fall time owing to the surface tension of the liquid or viscous mixture.

In order to obtain separated microbeads after curing of the protective sheath, it is advantageous to allow the droplets to enter a liquid layer in laminar flow in this procedure, with the flow direction corresponding to the fall direction.

These conditions can be achieved through various designs of corresponding apparatuses, as described in most detail in EP 0 735 940.

A simpler way of causing as little deformation as possible of the resultant droplets during the falling consists in allowing the droplets to fall into a foam layer which is located on the curing agent solution. Although this requires the addition of a suitable surfactant, it does, however, enable significantly simpler means to be used. A corresponding process is described in DE 41 25 133 C2.

Besides the composition of the starting solution comprising polymerisable monomers, such as, for example, styrene, crosslinking agent, free-radical former, accelerator and inhibitor, and the polymerisation conditions (temperature), the additives added to the solution play a crucial role for the properties of the polystyrene beads formed. In order, for example, to graft hydrophilic end groups onto the polystyrene beads, substances containing a lipophilic moiety and a hydrophilic moiety are added to the starting solution. The lipophilic moiety is bound into the polymeric structure of the polystyrene, whereas the hydrophilic moiety diffuses more to the surface of the polystyrene beads, where it can serve as docking moiety for further chemical reactions.

A further embodiment of the invention consists in adding these molecules to be grafted on to the protective colloid in order that the molecules to be grafted on can only be bonded to the surface of the polymeric core during the polymerisation which has already begun.

Particularly suitable for the outer protective colloid shell are alginates, i.e. sodium alginate or ammonium alginate in aqueous solution are employed for the solution. These are converted into low-solubility metal alginates in the aqueous solution, which contains divalent or trivalent ions. In order to reduce the surface tension, the metal ion solution also comprises a nonionic surfactant and/or an alcohol, such as ethanol, propanol or butanol.

The present invention is refined in that the curing solution for the alginate does not comprise any divalent or trivalent metal salts, but instead is adjusted to a pH of 4-5 using organic acids, such as citric or tartaric acid. This causes conversion of the sodium alginate or ammonium alginate in the protective shell into alginic acid, which has low solubility and thus gives the protective capsule sufficiently high strength to be able to allow the curing of the styrene/crosslinking agent to proceed without problems.

The detachment of the Me^{2+/3+} alginate protective sheath is effected by complexing agents, which have a much higher complex formation constant than the alginate molecule. This purpose is served by complexing agents such as ethylenediamineacetic acid, nitrilotriacetic acid or alkali metal salts thereof and/or mixtures of these complexing agents. In alkaline aqueous solution, the Me^{2+/3+} alginate protective sheaths of the polystyrene microbeads are dissolved through the Me^{2+/3+} ions being complexed by the chelating agent, and the soluble alkali metal salt of the alginate re-forming. The polystyrene microbeads can in this form be separated off from the solution by filtration/sieving, washed and dried.

As already stated, it is not just styrene microbeads that can be produced in an elegant manner by this process. In modified form, other polymerisable monomers, such as styrene derivatives, unsaturated olefins, such as butadiene, pentadiene, vinyl and (meth)acrylic compounds, cyclic ethers, cyclic esters, cyclic amides, such as oxiranes, lactones or lactams, unsaturated cyclic hydrocarbons, cyclic isocyanates, cyclic H-acidic amino compounds, cyclic hydroxyl or carboxyl compounds, individually or in the form of a mixture, can be converted in this way into polymer microbeads. These microbeads can be used in combinatorial synthesis, as support materials for ion exchangers, as support material for polymer-supported liquid-phase syntheses, in general as support materials for reactive moieties or as support material for oligonucleotide synthesis. However, they can also be employed in solid-phase synthesis.

### EXAMPLES

For better understanding and illustration of the invention, examples are given below which are within the scope of protection of the present invention, but are not suitable for restricting the invention to these examples.

### Example 1

Inner casting solution:

Monomeric styrene, stabilised with 50 ppm of 4-tert-butylpyrocatechol, was mixed with 1% of divinylbenzene, 5.6% of tert-butyl peroxyneodecanoate and 0.7% of N,N-dimethylaniline, and the mixture was pre-polymerised at 36° C. for 2 hours and 20 minutes.

Outer casting solution

1.5% of polyethylene glycol were added to a solution of sodium alginate (1.8%) in deionised water.

Curing solution:

2% CaCl₂ solution containing 1% of surfactant.

The inner casting solution and the outer casting solution were fed under slight excess pressure to a coaxial double nozzle having an internal diameter of 100 μm and an external diameter of 600 μm and formed into droplets by means of vibration at a frequency of 3000 Hz.

The core/shell microbeads obtained were fed after the nozzle to the curing solution, where the shells of the capsules were cured. After a curing time of 1 hour, the microbeads were washed with water and heat-treated at 60° C. for 24 hours.

The inner styrene mixture beads, which were still liquid after curing of the shell, were then polymerised. The outer protective shell of Na alginate was dissolved in 10% nitrilotriacetic acid solution.

The polystyrene microbeads obtained were separated off from the nitrilotriacetic acid solution, washed with water and dried. Microbeads of partially crosslinked polystyrene having a diameter of 150±25 μm were obtained.

### Example 2

The procedure was as in Example 1, but the inner solution was pre-polymerised for 16 hours at 280° C. and then cast as in Example 1 using an inner nozzle (diameter 150 μm) and an outer nozzle (diameter 800 μm).

After dissolution of the outer shell, polystyrene microbeads having diameters of 240±20 μm were obtained.

### Example 3

The inner solution from Example 1 was varied by using the free-radical former methyl ethyl ketone peroxide in a concentration of 9.5%. The accelerator used was 1.0% of N,N-diethylaniline. The pre-polymerisation was carried out at 44° C. for a period of 12 hours.

The vibration droplet formation was carried out with a coaxial double nozzle having an internal diameter of 120 μm and an external diameter of 100 μm.

After curing and removal of the shell, polystyrene microbeads having diameters of 200±15 μm were obtained.

### Example 4

4% of dibenzoyl peroxide were added to monostyrene containing 70 ppm of hydroquinone and an addition of 1.0% of methyl methacrylate and 0.5% of divinylbenzene, the mixture was pre-polymerised for 3 hours at 33° C., and this inner solution was cast as described in Example 1.

Microbeads comprising polystyrene crosslinked with methyl methacrylate and divinylbenzene were obtained. The diameters were 160±20 μm.

### Example 5

The inner solution had the same composition as in Example 4, but the methyl methacrylate content was 1.8% and the divinylbenzene content was 0%. Polystyrene/methyl methacrylate microbeads having diameters of 145±30 μm were obtained.

### Example 6

2.4% of butyl methacrylate and 6% of dibenzoyl peroxide were added as crosslinking agent to the inner solution from Example 5 with an otherwise identical composition.

This inner solution was pre-polymerised at 40° C. for 19 hours and then formed into droplets using the double nozzle process. Polystyrene/butyl methacrylate microbeads having diameters of 155±20 μm were obtained.

### Example 7

An inner casting solution was prepared as in Example 1.

An electrolyte component of 3.5% of NaCl was added to the outer casting solution.

The two solutions were cast as in Example 1. Polystyrene microbeads having a more uniform particle size distribution and somewhat higher strength were obtained. After curing, some of the cured polystyrene microbeads were removed from the protective sheath using an alkaline ethylenediaminetetraacetic acid solution. This complexing agent likewise results in conversion of the Ca alginate into soluble Na alginate in the alkaline region.

### Example 8

Triacrylyl cyanurate as monomer with three unsaturated reactive groups for crosslinking was added to the inner casting solution from Example 1 as crosslinking agent monomer instead of divinylbenzene. Crosslinked polystyrene microbeads having more rigid properties were obtained.

### Example 9

Ditrimethylolpropane tetraacrylate was added to the inner casting solution from Example 1 as crosslinking agent. The polystyrene microbeads obtained were crosslinked to a much greater extent by the tetraunsaturated crosslinking molecule.

### Example 10

The inner casting solution from Example 1 was provided with a ternary system, i.e. with two further crosslinking agents in addition to the styrene, instead of with a binary system. Diallyl phthalate and methyl methacrylate were employed.

The polystyrene microbeads obtained consisted of an interpenetrating network of the three components.

### Example 11

Pentaerythritol diallyl ether was additionally added to the inner casting solution from Example 1. The two reactive double bonds of this monomer participated in the polymerisation, i.e. were crosslinked. The free terminal OH groups can be utilised directly for the grafting-on of molecules for combinatorial synthesis or other chemical reactions, while the remainder of the pentaerythritol diallyl ether molecule is crosslinked with the styrene.

### Example 12

The inner casting solution consisted of styrene, 10% of maleic anhydride and 5% of 6-aminohexanoic acid. The polymerisation carried out after casting and the formation of alginate-encapsulated styrene/maleic acid/amino acid was carried out at 75° C. over the course of 48 hours.

The detachment of the protective capsule of Ca alginate was likewise carried out using alkaline complexing agent as in Example 1.

The polystyrene-maleic acid copolymers obtained contained grafted-on amino acid.

1. Microbeads having an inner spherical core which comprises one or more polymerisable monomer(s), crosslinking agents, additives and peroxide, and an outer bead shell which consists of a chemically cured protective colloid.

2. Microbeads according to claim 1, characterised in that the inner core comprises, as polymerisable monomer(s), styrene, styrene derivatives, unsaturated olefins, such as butadiene, pentadiene, vinyl and (meth)acrylic compounds, cyclic ethers, cyclic esters, cyclic amides, such as oxiranes, lactones or lactams, unsaturated cyclic hydrocarbons, cyclic isocyanates, cyclic H-acidic amino compounds, cyclic hydroxyl or carboxyl compounds, individually or in the form of a mixture.

3. Process for the production of microbeads from a polymer or copolymer having a narrow particle size distribution in the range from 50 to 2000 μm and a uniform bead shape, characterised in that
a) droplets of a reactive mixture which comprises one or more polymerisable monomer(s) and has a liquid to viscous flowable consistency emerging from a nozzle
b) are surrounded with a separation and protective liquid emerging from a coaxially arranged outer nozzle and
c) are introduced dropwise into a curing solution under suitable conditions under which the bead shape formed during the falling is retained,
d) the outer protective sheath is cured under the influence of the curing agent solution,
e) the mixture comprising one or more polymerisable monomer(s) is polymerised and cured in spherical shape after the temperature has been increased without the beads formed agglomerating or sticking together,
f) the outer protective sheath is removed by a chemical reaction after the polymerisation and curing, and
g) the microbeads are separated off from the solution.

4. Process according to claim 3, characterised in that the reactive mixture comprising one or more polymerisable monomer(s) comprises a crosslinking molecule, a polymerisation catalyst and optionally further additives.

5. Process according to claims 3 and 4, characterised in that the polymerisable monomers employed are styrene, styrene derivatives, unsaturated olefins, such as butadiene, pentadiene, vinyl or (meth)acrylic compounds, cyclic ethers, cyclic esters, cyclic amides, such as oxiranes, lactones or lactams, unsaturated cyclic hydrocarbons, cyclic isocyanates, cyclic H-acidic amino compounds, cyclic hydroxyl or carboxyl compounds, in pure form or in the form of a mixture.

6. Process according to claims 3 and 4, characterised in that the reactive mixture comprises a crosslinking molecule selected from the group consisting of divinylbenzene, diethylene glycol bis(allyl carbonate), diallyl phthalate, methylstyrene, methyl acrylate, methyl methacrylate, hydroxyethyl methacrylate, 1,4-butanediol dimethacrylate, trimethylolpropane trimethacrylate and other di- and trivinyl compounds and di-, tri- and tetraacrylates or methacrylates, and mixtures thereof, and, as catalyst, a free-radical former selected from the group consisting of dibenzoyl peroxide, dilauroyl peroxide, tert-butyl peroctanoate, tert-butyl perbenzoate, dicumyl peroxide, di-tert-butyl peroxide, cumene hydroperoxide, tert-butyl hydroperoxide, tert-butyl peroxyneodecanoate, other peroxyesters and mixtures thereof.

7. Process according to claims 3 and 4, characterised in that the reactive mixture comprises an accelerator selected from the group consisting of N,N-dimethylaniline, N,N-dimethyl-o-toluidine, N,N-diethylaniline, Co octanoate and Cu octanoate.

8. Process according to claims 3 and 4, characterised in that the reactive mixture comprises inhibitors selected from the group consisting of hydroquinone, p-benzoquinone, pyrocatechol, tert-butylhydroquinone, 4-tert-butylpyrocatechol, 3,5-di-tert-butylpyrocatechol, 2,5-di-tert-butylhydroquinone and hydroquinone monomethyl ether.

9. Process according to claims 3 to 8, characterised in that the reactive mixture is pre-polymerised, so that a mixture of viscous flowable consistency which can be formed into droplets is obtained.

10. Process according to claim 9, characterised in that the prepolymerisation is carried out in a water bath or a fan-assisted oven at a temperature of 30-600° C. over a period of 1-8 hours.

11. Process according to claims 3 to 8, characterised in that the reactive mixture comprises additives containing lipophilic or hydrophilic groups.

12. Process according to claims 3 to 8, characterised in that the separation and protective liquid comprises additives containing lipophilic or hydrophilic groups.

13. Process according to claims 3 to 12, characterised in that the separation and protective liquid comprises alginates in aqueous solution, which are converted into low-solubility metal alginates in the curing agent solution, which optionally comprises a nonionic surfactant and/or an alcohol from the group consisting of ethanol, propanol and butanol.

14. Process according to claims 3 to 12, characterised in that the separation and protective liquid comprises alginates in aqueous solution, which are converted into alginic acid in a curing agent solution, which has been adjusted to a pH of from 4 to 5 using an organic acid from the group consisting of citric acid and tartaric acid, with formation of a low-solubility protective capsule.

15. Process according to claims 3 to 14, characterised in that the low-solubility protective capsule is detached, after the polymerisation and curing of the inner spherical bead, by means of a solution which comprises complexing agents selected from the group consisting of ethylenediamineacetic acid, nitrilotriacetic acid and alkali metal salts thereof and/or mixtures of these complexing agents, or by conversion of the low-solubility alginates into their soluble alkali metal or ammonium salts.

16. Process according to claims 3 to 14, characterised in that the low-solubility protective capsule is detached, after the polymerisation and curing of the inner spherical bead, by means of a solution which comprises strong hydroxide solutions from the group consisting of alkali metal hydroxide solutions, through formation of the soluble alkali metal salts.

17. Use of the microbeads produced according to claims 3 to 16 as support materials for ion exchangers, as support material for polymer-supported liquid-phase syntheses.

18. Use of the microbeads produced according to claims 3-16 as support materials for reactive moieties, as support material for oligonucleotide synthesis.

19. Use of the microbeads produced according to claims 3-16 in combinatorial synthesis.

20. Use of the microbeads produced according to claims 3-16 in solid-phase synthesis.
